(19) United States
(12) Patent Application Publication
(10) Pub. No.: US 2022/0386564 A1
(43) Pub. Date: Dec. 8, 2022

(54) IMPROVED ANIMAL TAG APPLICATOR

(71) Applicant: Ceres Tag Pty Ltd, Red Hill (AU)

(72) Inventor: David Ian Smith, Red Hill (AU)

(73) Assignee: Ceres Tag Pty Ltd, Red Hill (AU)

(21) Appl. No.: 17/624,509

(22) PCT Filed: Jul. 2, 2020
(86) PCT No.: PCT/AU2020/050688

§ 371 Date: Jan. 3, 2022

(30) Foreign Application Priority Data
Jul. 3, 2019 (AU) 2019902357

(51) Int. Cl. A01K 11/00

(52) U.S. Cl. CPC A01K 11/002

(57) ABSTRACT

An animal tag applicator comprising: a fixed jaw member and a movable jaw member comprising oppositely arranged tag engaging surfaces for engaging an animal tag therebetween; a handle extending downwardly from the fixed jaw member; a supporting portion extending outwardly from the fixed jaw member to support the movable jaw member; and a lever comprising a first lever portion linked to the movable jaw and a second lever portion adapted for movement relative to the handle wherein the lever is movably linked to said handle such that a movement of the second portion of the lever towards the handle results in movement of the first portion of the lever and simultaneously effects a substantially linear movement of the linked moveable jaw towards the fixed jaw.

### TECHNICAL FIELD

The present invention relates to an applicator for animal ear tags.

### BACKGROUND

Any references to methods, apparatus or documents of the prior art are not to be taken as constituting any evidence or admission that they formed, or form part of the common general knowledge.

Many forms of applicators for fixing an ear tag to an animal's ear well known. The most common applicator tool is a pliers type applicator which comprises a pair of levers pivotally coupled together. To one side of the pivot the levers are formed as handles whilst on the other side they are formed as jaws which are used for pushing one or more retainers through the animal's ear into the ear tag.

One of the problems associated with a pliers type applicator is that the jaws of the tool move on an arc which can lead to misalignment of one tag part in relation to the other during installation of the tag in the animal's ear. By way of example, the misalignment can lead to broken pins and retainers because as the jaws move in an arc the pin can become bent or broken. If the tag components are incorrectly placed on the applicator a tangential or sideways force can arise due to the movement of the jaws in arc which damages the pin. A further reason for damage can be movement of the animals head before the pin is withdrawn from the male component of the animal. This arises especially when the animals head is not secured or otherwise firmly retained. Accordingly, it would be desirable to provide an applicator tool that can provide possibly avoid the movement of the jaws in an arc.

Another issue associated with pliers type ear tag applicators is that a large amount of force is often required for grasping the handles and bringing them close to each other from an initial starting point where the handles are held apart by a large enough distance in order to apply a sufficient force by effecting movement of the jaws in an arc. Therefore, it would be desirable to be able to reduce the maximum distance between the levers whilst still being able to apply sufficient force for fastening the animal tag onto an animal's ear.

Yet another criteria which must be met with an applicator tool is that there must be sufficient space between the parts of the tag when retained by the retention means to facilitate the easy positioning of the ear (of an animal) in between the jaws. One way in which this gap can be obtained is to have the jaws pivot sufficiently away from one another when the applicator tool is opened. In this manner the required gap is provided, however, the applicator is often difficult to handle due to the handles thereof being too far apart for ease of use.

In view of the above, it is desirable to provide an improved ear tag applicator.

### SUMMARY OF INVENTION

In one aspect, the invention provides an animal tag applicator comprising:

a fixed jaw member and a movable jaw member comprising oppositely arranged tag engaging surfaces for engaging an animal tag therebetween;

a handle extending downwardly from the fixed jaw member;

a supporting portion extending outwardly from the fixed jaw member to support the movable jaw member; and

a lever comprising a first lever portion linked to the movable jaw and a second lever portion adapted for movement relative to the handle wherein the lever is movably linked to said handle such that a movement of the second portion of the lever towards the handle results in movement of the first portion of the lever and simultaneously effects a substantially linear movement of the linked moveable jaw towards the fixed jaw.

In an embodiment, the supporting portion extends in an orthogonal and outwardly direction relative to the fixed jaw and the handle.

In an embodiment, the handle depends downwardly relative to the supporting portion.

In an embodiment, the fixed jaw, the supporting portion and the handle are integrally formed.

In an embodiment, the supporting portion comprises a sliding arrangement to allow the movable jaw to slide along at least a portion of the supporting portion thereby allowing movement of the movable jaw towards the fixed jaw.

In an embodiment, the sliding arrangement comprises engagement formations provided along a lower portion of the movable jaw for slidably engaging the supporting portion.

In an embodiment, the sliding arrangement comprises engagement formations provided along lateral walls of a rear portion of the movable jaw member for slidably engaging channels provided within a housing of the supporting portion.

In an embodiment, the lever comprises a linking portion positioned between the first and second lever portions for pivotally linking the lever and allowing pivotal movement of the lever relative to the handle to effect the movement of the movable jaw towards the fixed jaw.

In an embodiment, the handle further comprises a movable hand engaging portion configured for movement along a body of the handle, the hand engaging portion being operable to be movable towards and away from the linking portion of the lever.

In an embodiment, the animal tag applicator further comprises a biasing arrangement positioned in between the first portion of the lever and the movable jaw to provide a biasing force to initially resist movement of the first lever portion in a direction towards the movable jaw and whereby once the biasing force of the biasing arrangement has been overcome, further movement of the first lever portion effects movement of the movable jaw towards the fixed jaw.

In an alternative or additional embodiment the biasing arrangement may be positioned between the second lever portion and the handle for applying a bias for resisting the pivotal movement of the second lever portion towards the handle.

In an embodiment, the animal tag applicator further comprises an adjustment mechanism for adjusting a bias applied by the biasing arrangement.

In an embodiment, the first portion of the lever is linked to a first linking portion of the movable jaw and wherein the biasing member is linked to a second linking portion of the movable jaw.

In an embodiment, the biasing member is elongate and extends between two ends, a first end of the biasing member being linked with the second linking portion of the movable jaw and the second end of the biasing member being linked with the supporting member.

In an embodiment, the movable jaw is positioned for sliding for within a cavity defined by a housing to surround and enclose the first and second linking portions of the movable jaw and the first lever portion therein.

In an embodiment, the animal tag applicator further comprises a guide member extending in a rearwardly direction relative to the engaging surface of the movable jaw, the guiding member being positioned for guiding movement of the first lever portion towards the movable jaw.

In an embodiment, the first portion of the lever comprises a slot for receiving the guiding member therein, the slot being shaped to limit upward or downward movement of the first lever portion relative to the guide member.

In an embodiment, the biasing member is positioned relative to the guide member to resist initial guided movement of the first lever along the guiding member towards the movable jaw.

In an embodiment, a rear portion of the movable jaw comprises two spaced apart rear portions for receiving the first portion of the lever when the second portion of the lever is pivoted towards the handle.

In an embodiment, a lower part of each of the rear portions comprises engagement formations for slidably engaging the support portion and allowing the movable jaw to slide along the support portion.

An animal tag applicator in accordance with any one of the preceding claims wherein the tag engaging surface in each of said jaws is recessed inwardly relative to an outer surface of the jaw for receiving a portion of the tag during use.

In an embodiment, the animal tag applicator further comprises an actuating arrangement for actuating one or more electronic components of the animal tag positioned between the fixed and movable jaws during use.

In an embodiment, the actuating arrangement comprises an RFID tag powered by a battery, said arrangement being located at or adjacent the tag engaging surface of the fixed jaw member.

In an embodiment, the animal tag applicator further comprises an indicator for indicating a state of operation of the animal tag positioned between the fixed and movable jaws during use.

In an embodiment, the animal tag applicator further comprises one or more stop members for limiting movement of the movable jaw member.

Preferably, the animal tag applicator comprises at least a first stop member for limiting movement of the movable jaw member in a direction towards the fixed jaw member and at least a second stop member for limiting movement of the movable jaw member in a direction away from the fixed jaw member

In another aspect, the invention provides an animal tag applicator comprising:

a fixed jaw member and a movable jaw member comprising oppositely arranged tag engaging surfaces for engaging an animal tag therebetween;

a lever comprising at least a first lever portion linked to the movable jaw by a linking arrangement such that pivotal movement of the lever simultaneously effects a substantially linear movement of the linked moveable jaw towards the fixed jaw.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1A is a rear perspective view of the ear tag applicator 100 in an open or non-fired position.

FIG. 1B is a rear perspective view of the ear tag applicator 100 in an open or non-fired position.

FIG. 2A is a front perspective view of the ear tag applicator 100 in an open or non-fired position.

FIG. 2B is a front perspective view of the ear tag applicator 100 in an open or non-fired position.

FIG. 3A is a rear perspective sectional view of the ear tag applicator 100 in an open or non-fired position.

FIG. 3B is a rear perspective sectional view of the ear tag applicator 100 in an open or non-fired position.

FIG. 4A is a right hand side view of the ear tag applicator 100 in an open or non-fired position.

FIG. 4B is a right hand side view of the ear tag applicator 100 in an open or non-fired position.

FIG. 5A is a left hand sectional side view of the ear tag applicator 100 in an open or non-fired position.

FIG. 5B is a left hand sectional side view of the ear tag applicator 100 in an open or non-fired position.

FIG. 6 is a frontal perspective view of an exemplary animal tag 300 adapted for use with embodiments of the ear tag applicator such as but not limited to the ear tag applicator 100 in accordance with the first embodiment or an ear tag applicator 200 in accordance with a second embodiment shown in FIGS. 7 to 15.

FIG. 7 is a frontal left hand side perspective view of the tag applicator 200.

FIG. 8 is a frontal right hand side perspective view of the tag applicator 200.

FIG. 9 is a rear right hand side perspective view of the tag applicator 200.

FIG. 10 is a right hand side view of the tag applicator 200.

FIG. 11A is a left hand side view of the tag applicator 200 shown in an open position.

FIG. 11B is a left hand side view of the tag applicator 200 shown in a fired position or closed position.

FIG. 12A is a rear view of the tag applicator 200.

FIG. 12B is a sectional view of the tag applicator 200 (across section D-D shown in FIG. 12A) shown in an open position.

FIG. 12 C is a sectional view of a tag applicator 200A shown in an open position

FIG. 12D is a sectional view of the tag applicator 200A (across section D-D shown in FIG. 12A) shown in a fired or closed position.

FIG. 13A is the frontal view of the tag applicator 200.

FIG. 13B is a sectional view of the tag applicator 200 (across section C-C shown in FIG. 13A) shown in an open position.

FIGS. 14A and 14B illustrate top and bottom views of the tag applicator 200.

FIG. 15 is an exploded perspective view (rear left side) of the tag applicator 200.

FIG. 16 is an exploded perspective view (rear right side) of the tag applicator 200.

### DETAILED DESCRIPTION OF PREFERRED EMBODIMENTS

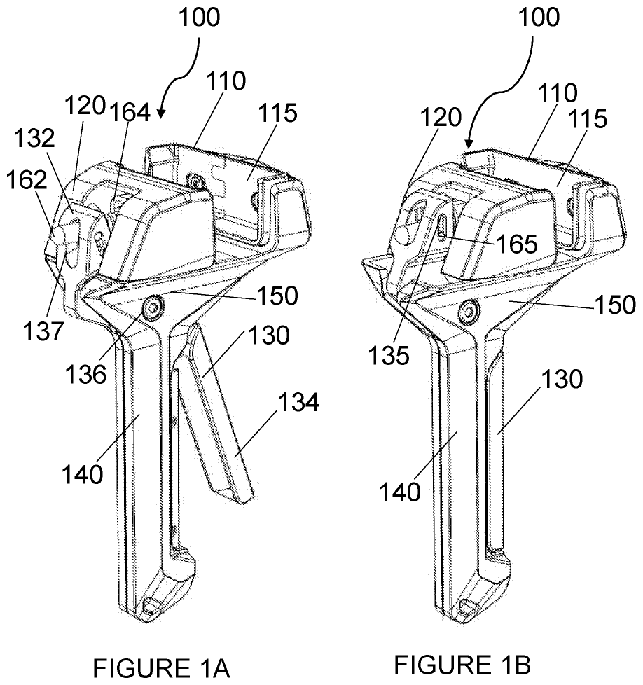

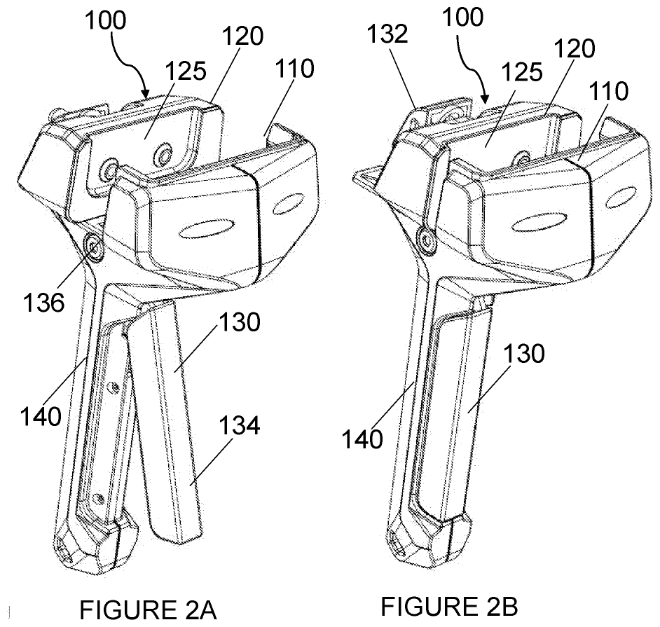

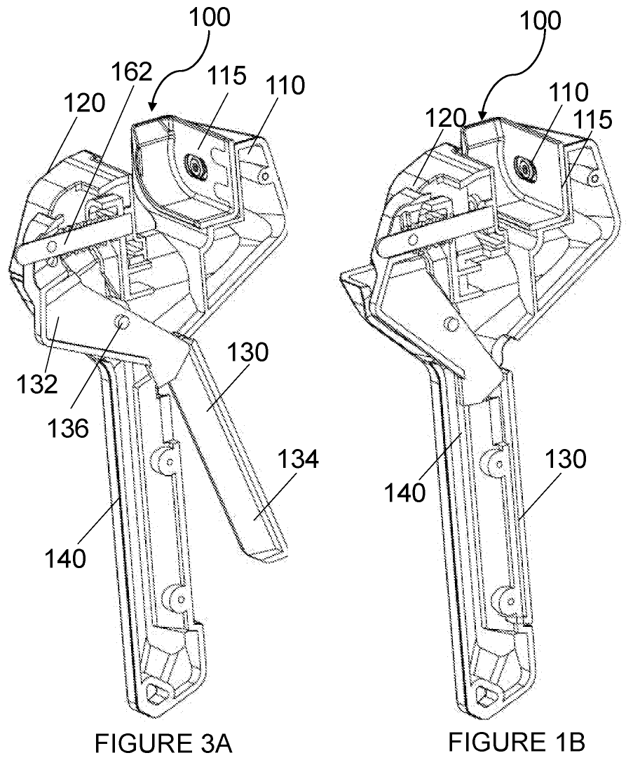

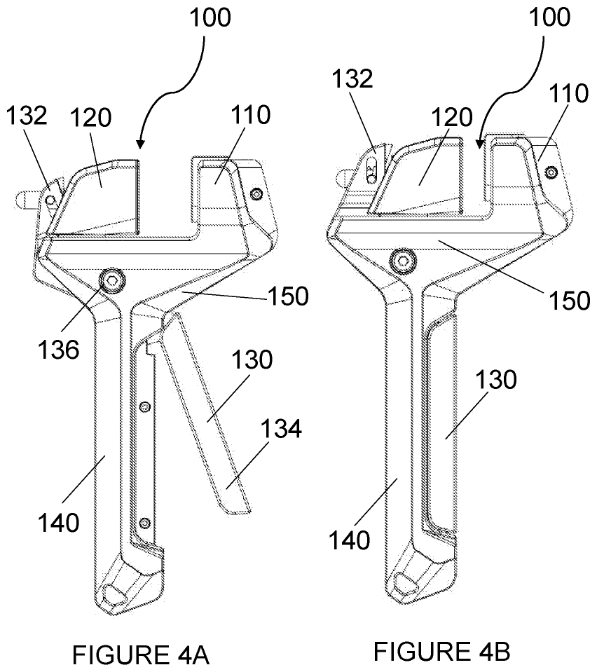

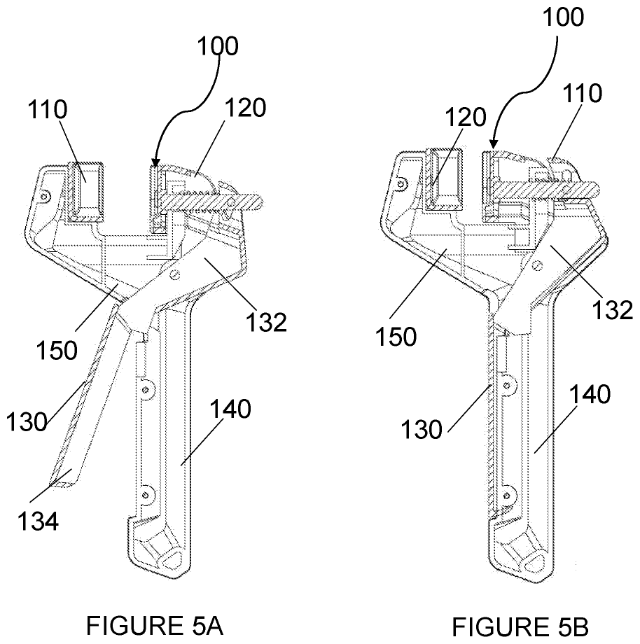

FIGS. 1 to 5 illustrate an embodiment of the animal tag applicator 100. Specifically, each of FIGS. 1A, 2A, 3A, 4A and 5A show the applicator 100 in an open or non-fired position and FIGS. 1B, 2B, 3B, 4B and 5B show the applicator 100 in a closed or fired position as will be described in the foregoing sections.

The ear tag applicator 100 comprises: a fixed jaw member 110 and a movable jaw member 120. Each of these jaw members 110 and 120 include generally rectangular tag engaging surfaces 115 and 120 respectively for engaging a surface of the tag (not shown) positioned in between the jaw members 110 and 120. The tag engaging surfaces 115 and 125 are slightly recessed relative to an outer peripheral portion of each jaw member 110 and 120 to allow the tag to be easily and securely positioned in between the jaw members 110 and 120.

The fixed jaw member 110 is integrally formed with an orthogonal and outwardly extending supporting portion 150 that supports the movable jaw 120. In the preferred embodiment of the ear tag applicator 100, the movable jaw 110 includes engagement formations located along a lower portion of the movable jaw 110. The engagement formations of the movable jaw 120 are adapted to engage a sliding arrangement provided on an upper portion of the supporting portion 150 that allows the movable jaw 110 to slide towards and away from the fixed jaw 110. In the presently described embodiment, the engagement formations of the movable jaw 110 are adapted to be received into recessed channels positioned along the upper portion of the supporting portion 150.

The ear tag applicator 100 also comprises a fixed handle 140 that depends downwardly from the supporting portion 150. The fixed handle 140, the supporting portion 150 and the fixed jaw 110 are integrally formed to form a singular unitary body. The applicator 100 also includes a movable lever 130 that is pivotally attached to the supporting portion 150 at a linking location 136 that allows the lever 130 to undergo pivotal movement relative to the unitary body formed by the fixed jaw 110, the handle 140 and the supporting portion 150. The lever 130 comprises an upwardly located first lever portion 132 and a downwardly located second lever portion 134 with the linking location 136 being positioned in between the first and second lever portions. During use, the pivotal movement of the lever 130 (namely movement of the second lever portion 134 towards the handle 140 by the user's fingers) results in movement of the first lever portion 132. The first lever portion 132 is interconnected with a rear portion of the movable jaw 120 (as will be explained in the foregoing sections) such that arcuate movement of the first lever portion 132 towards the movable jaw 120 results in linear movement of the movable jaw 120 towards the fixed jaw 110.

The ear tag applicator 100 also includes an elongate guide member 162 that extends rearwardly relative to the tag engaging surface 125 for guiding movement of the first lever portion 132. The first lever portion 132 includes an elongate slot 137 in a rear part of the first lever portion 132 (which is generally vertical when the applicator is in an open or non-fired position—See FIG. 1A) that is dimensioned to receive the guide member 162. The length of the slot 137 also limits the arcuate movement of the first lever portion 132 (and in turn the movement of the lever 130). FIG. 1A shows the applicator in an open or non-fired position whereby the guide member 162 is positioned at the upper end of the slot 137. Similarly, as shown in FIG. 1B, in the fired position, the guide member 162 is located at a lower end of the slot 137. Therefore, the length of the slot 137 limits the extent of movement for the lever 130. A retaining pin 165 is also provided in the guide member 162. The retaining pin 165 extends transversely from the guide member 162 and is received in a second slot 135 that is provided at a side wall part of the first lever portion 132. Once again, the retaining pin 165 and the second slot 135 also serve the purpose of limiting the range of arcuate movement for the first lever portion 132.

A biasing member in the form a biasing spring is positioned in between the first lever portion 132 and the movable jaw member 120. The spring 164 is positioned in between a frontal part of the first lever portion 132 and a rear part of the movable jaw member 120 with the guidance member 162 passing through the lumen of the spring member 164. The positioning of the spring 164 in combination with the guidance member allows a user to move the second lever portion 134 towards the handle which in turn results in limited arcuate movement of the first lever portion 132 and simultaneous linear movement of the movable jaw 120 towards the fixed jaw. In a neutral position (when no force is applied on the second lever portion), the biasing force of the spring member 164 applies sufficient force on the first lever portion to push the lever 130 back into the open non-firing position.

The above described configuration of the spring member 164 in combination with the guide member 162 also allows the initial spacing (in the open or no-fired position) between the movable jaw 120 and fixed jaw to be varied for accommodating tags of varying thicknesses. By way of example, using a longer spring 164 would result in the overall spacing between the movable jaw 120 and the fixed jaw 110 to be reduced. Similarly, a grub screw may also be used in conjunction with the elongate guide member 162 to vary the bias applied by the spring and thereby changing the neutral spacing between the movable jaw 120 and the fixed jaw 110.

The applicator tool according to embodiment of the invention comprises jaws 110 and 120 that can be sufficiently spaced apart to permit ready positioning on an animal's ear in between the jaws. In addition, however, there is provided the added advantage of an applicator tool having a lever ratio which is higher than that obtained with equivalent sized known applicators. For example, most known applicators have a lever ratio of approximately 2:1 and adequate space for the positioning of the animal's ear between the tag parts when installed in the applicator. Usually any increase in the space between the ear tag parts results in a lowering of the lever ratio especially if the applicator tool is to remain of dimensions which can be easily handled by the user. With the applicator 100 of the presently described embodiment, a good distance between the ear tag parts is achieved without any sacrifice of the lever ratio. In fact, the applicator can have a lever ratio at the actual installation of the tag in the order of 3:1. As a result, a high lever ratio is attained at the precise moment it is required which is during installation of the tag.

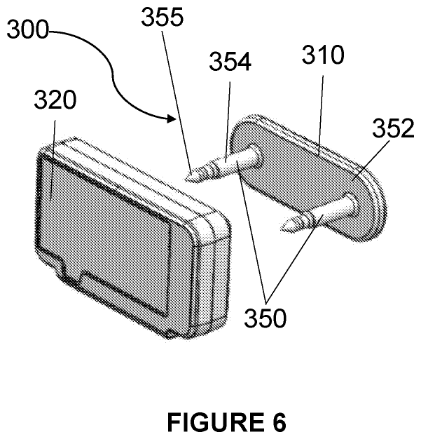

FIG. 6 illustrates an exemplary and non-limiting animal tag 300 that may be used in conjunction with the ear tag applicator described herein. The animal tag 300 also comprises a first tag member 310 adapted to be mounted to an inner surface of the animal's ear and a second tag member 320 adapted to be mounted to the outer surface of the animal's ear. Second tag member 320 comprises a main enclosure or housing that houses a PCB, an RFID tag, a battery (not shown), a chassis for supporting a solar array and the battery, and a retaining arrangement 360 therein. These components have been described in more detail in co-pending PCT Application No. PCT/AU2019/050459.

The animal tag 300 also includes a connecting arrangement providing an attachment member 350 that is used for interconnecting the first and second tag members 310 and 320. The attachment member 350 includes a head 352 and an elongate shank 354 having a conical end 355. During use, the shank 354 extends from the first tag member 310 and into a bore extending into the second tag member 320 from an opening of the second tag member 320.

The head 352 of the attachment member 350 is located within the first tag member 310. This is preferably achieved through an overmoulding process whereby the shank 354 of the attachment member 350 passes through an opening (not shown) in the first tag member 310 and a rear panel is overmoulded onto the attachment member 350. The animal tag 300 is also provided with a retaining arrangement 360, mentioned above, for retaining the shank 354 in the second tag member 320. The opening 323 of the second tag member 320 receives the end portion 355 of the shank 354.

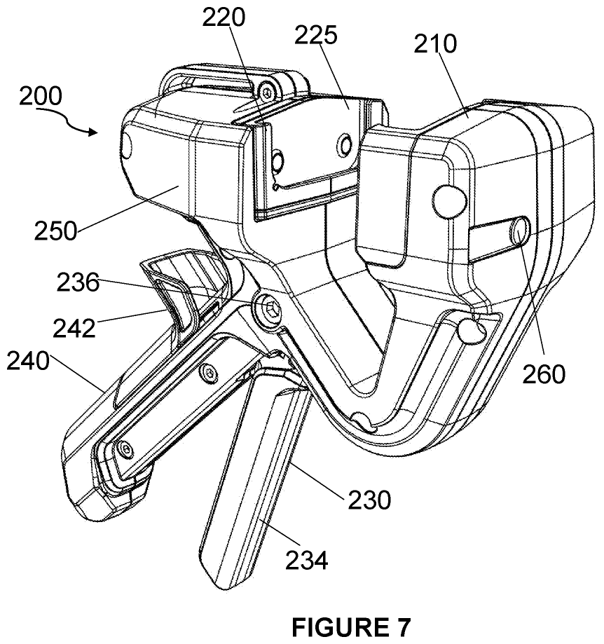

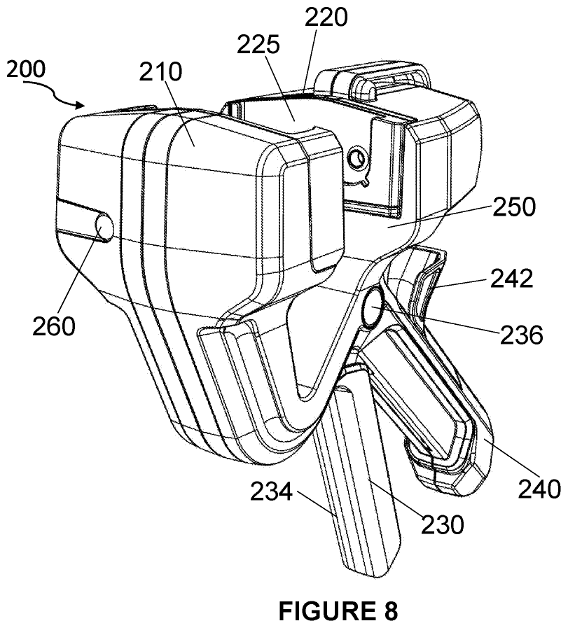

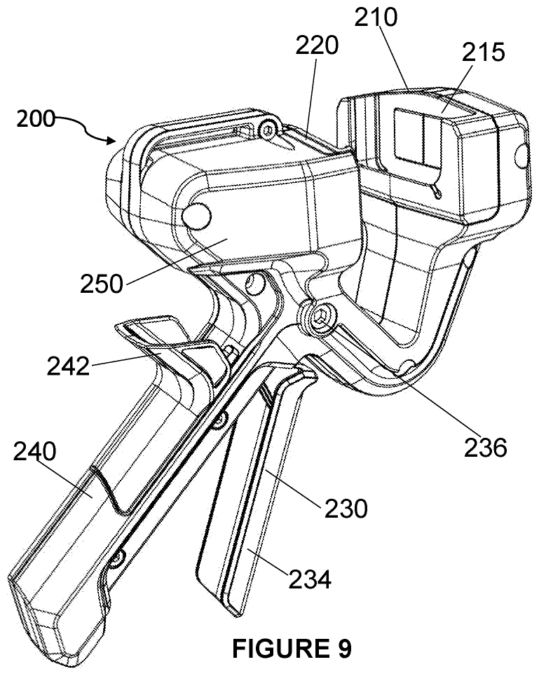

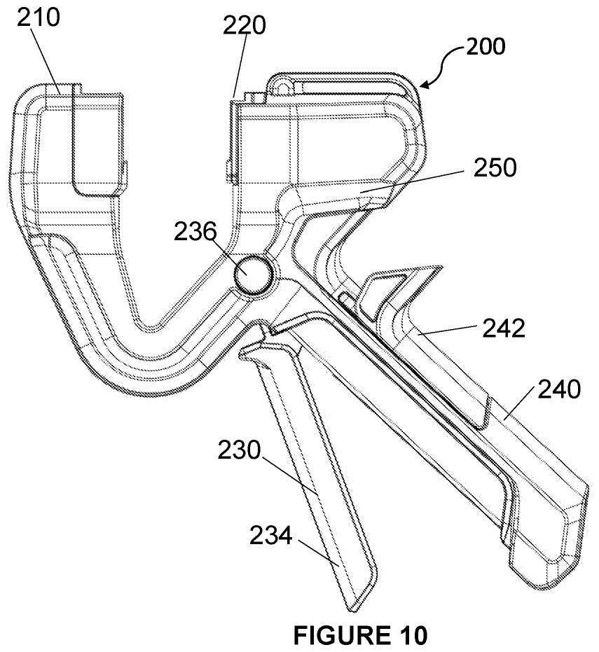

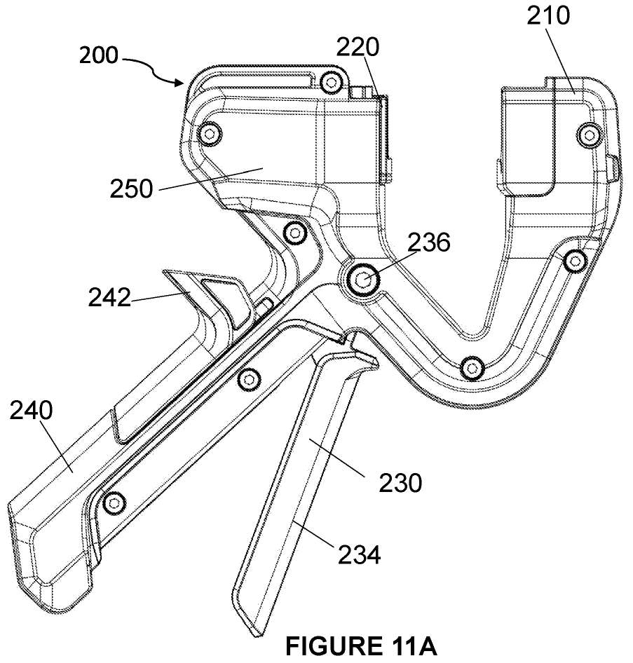

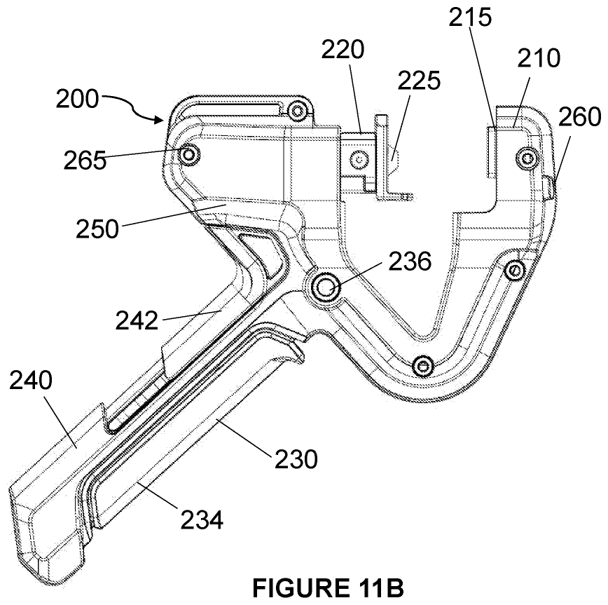

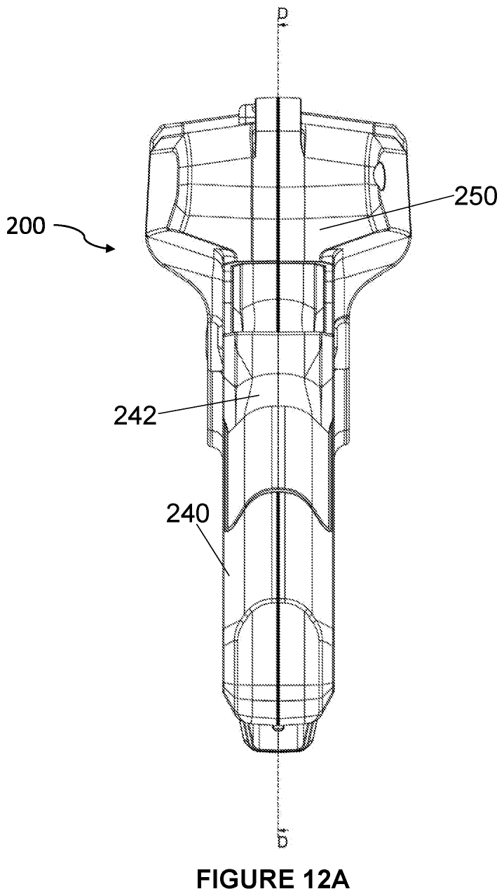

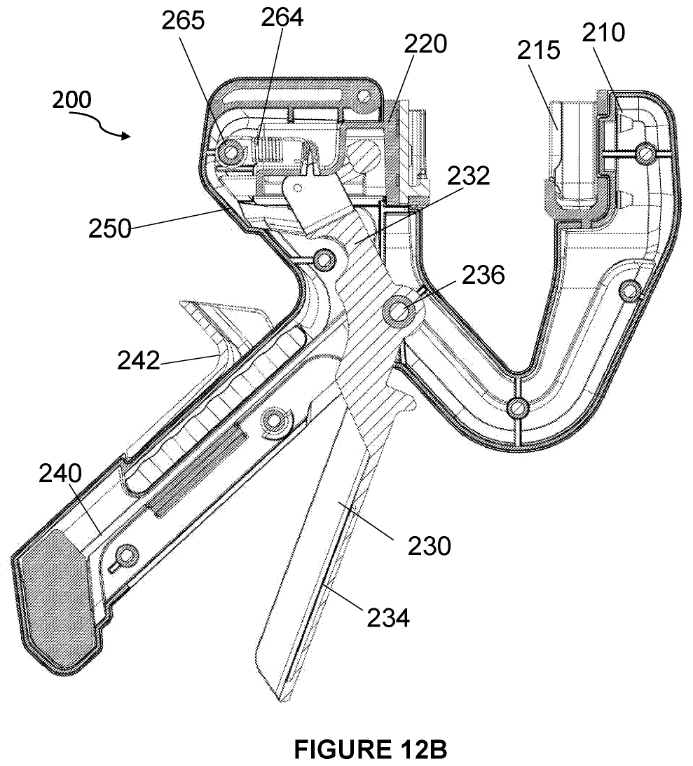

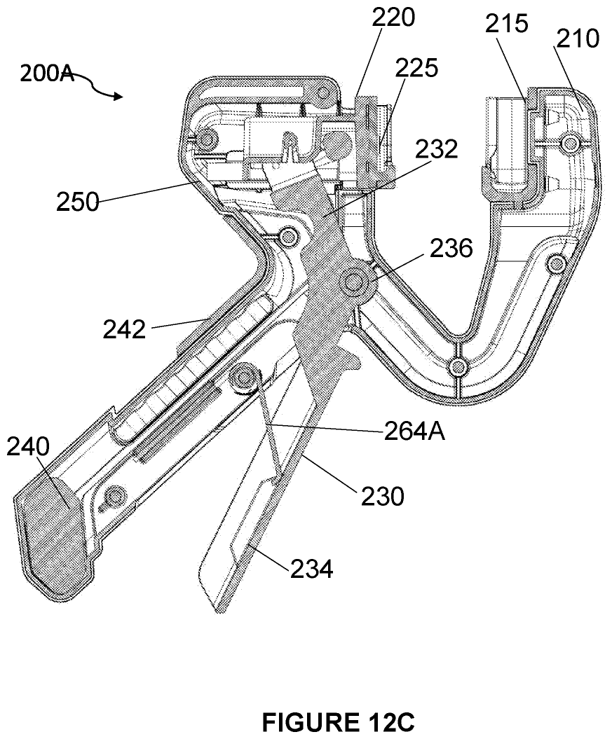

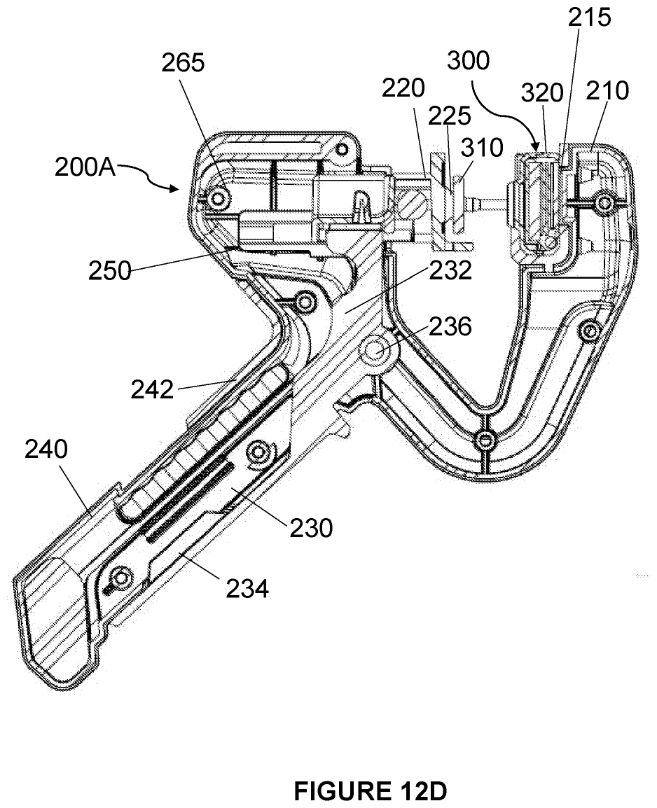

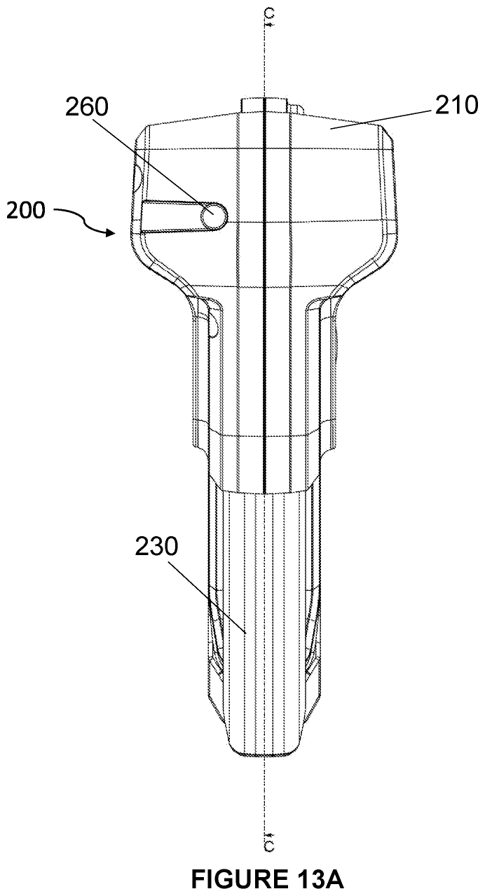

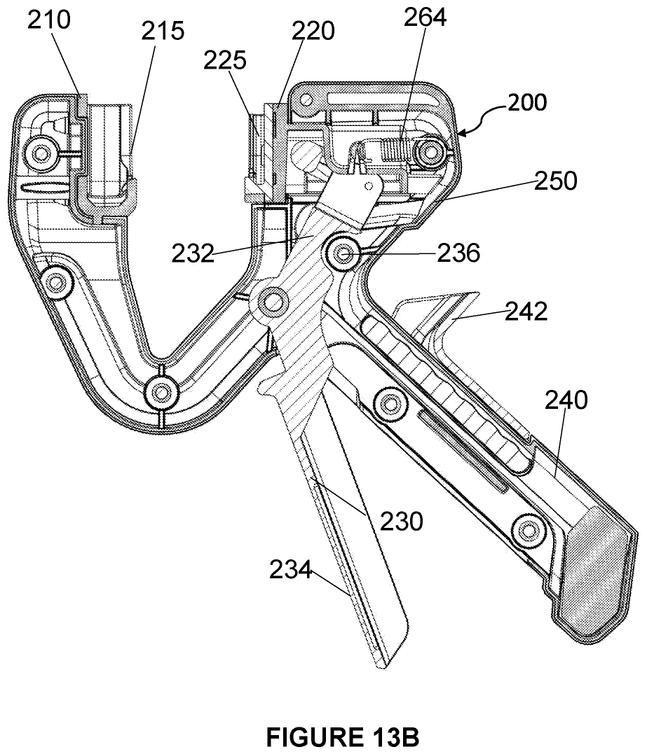

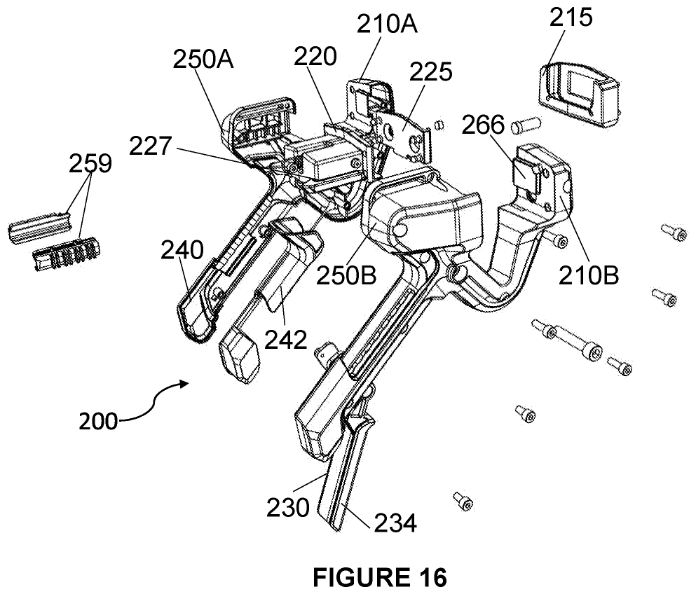

Referring to FIGS. 7 to 16, we refer to a second embodiment of an ear tag applicator 200 that comprises: a fixed jaw member 210 and a movable jaw member 220. Each of these jaw members 210 and 220 include generally rectangular and recessed tag engaging surfaces 215 and 225 respectively for engaging a surface of a an ear tag (such as but not limited to the tag shown) positioned in between the jaw members 210 and 220. FIGS. 11B and 12C show the ear tag applicator 200 in a fired position with the animal tag 300 positioned in engagement with the tag engaging surfaces 215 and 225. In some embodiments, tag engaging surface 215 may be shaped to receive and engage a frontal portion of the housing of the second tag member 320 (shown in FIG. 6) whereas tag engaging surface 225 may be in engagement with the head portions of the first tag member 310 (shown in FIG. 6). It would also be understood that the shape and configuration of the tag engaging surfaces may be varied in accordance with the configuration of the ear tag being used. In the preferred embodiment, the tag engaging surfaces 215 and 225 are slightly recessed relative to an outer peripheral portion of each jaw member 210 and 220 to allow the tag to be easily and securely positioned in between the jaw members 210 and 220.

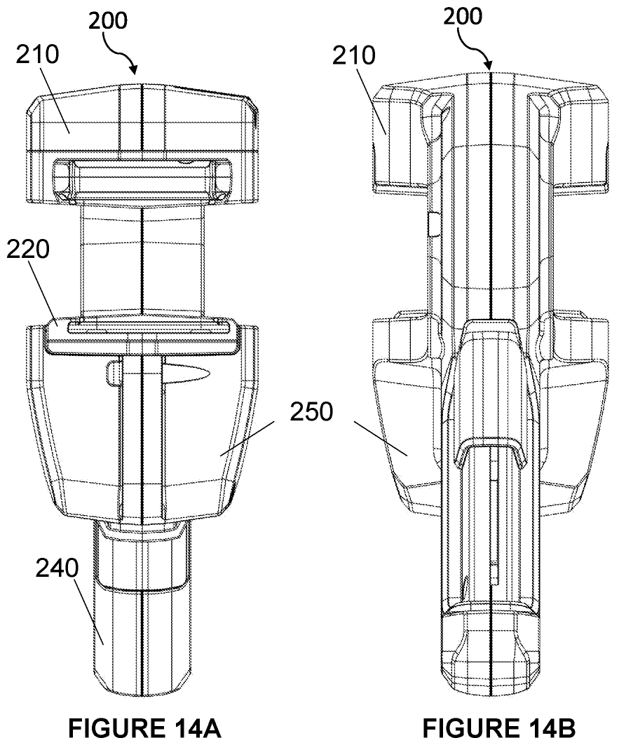

The fixed jaw member 210 is integrally formed with an orthogonal and outwardly extending supporting portion 250 that supports the movable jaw 220. In the preferred embodiment of the ear tag applicator 200, the movable jaw 210 includes engagement formations located along a lower side wall portions 223 of the movable jaw 210. The side wall portions are located rearwardly relative to the tag engagement surface 225 and these side wall portions extend in a rear perpendicular direction relative to the tag engagement surface 225. The engagement formations of the movable jaw 220 are adapted to be received into engagement channels 259 (shown in FIG. 14) provided within the supporting portion 250 that allows the movable jaw 210 to slide towards and away from the fixed jaw 210.

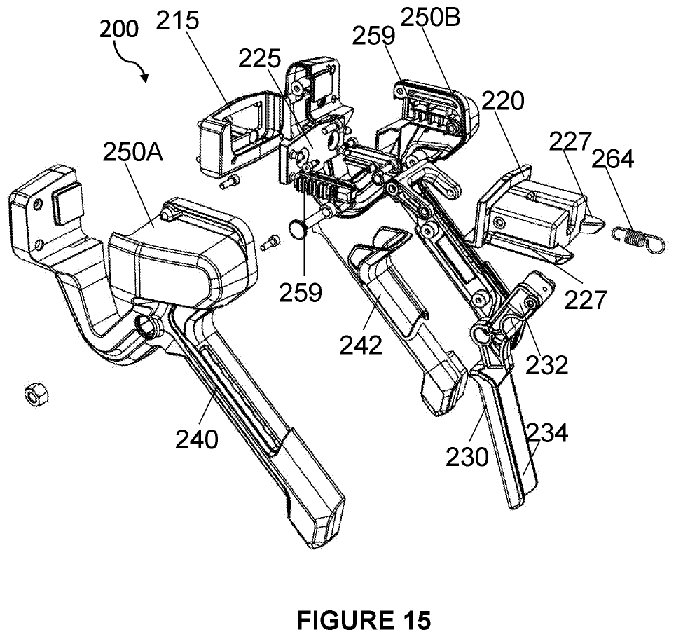

In the presently described embodiment, profiled engagement formations of the movable jaw body 210 provide the sliding arrangement 227 adapted to be received into recessed channels 259 (See FIGS. 14 and 15) positioned along inner portions of housing members 250A and 250B that form the supporting portion 250.

The ear tag applicator 200 also comprises a fixed handle 240 that depends downwardly from the supporting portion 250. The fixed handle 240, the supporting portion 250 and the fixed jaw 210 are integrally formed to form a singular unitary body. The applicator 200 also includes a movable lever 230 that is pivotally attached to the supporting portion 250 at a linking location 236 that allows the lever 230 to undergo pivotal movement relative to the unitary body formed by the fixed jaw 210, the handle 240 and the supporting portion 250. The lever 230 comprises an upwardly located first lever portion 232 and a downwardly located second lever portion 234 with the linking location 236 being positioned in between the first and second lever portions. During use, the pivotal movement of the lever 230 (namely movement of the second lever portion 234 towards the handle 240 by the user's fingers) results in movement of the first lever portion 232. The first lever portion 232 is interconnected with a rear portion of the movable jaw 220 (see FIGS. 11B and 12B) such that arcuate movement of the first lever portion 232 towards the movable jaw 220 results in linear movement of the movable jaw 220 towards the fixed jaw 210 by way of effecting a sliding movement of the movable jaw 220 relative to the supporting member 250.

The first lever portion 232 is linked with a first rear portion of the movable jaw 220 whereby pivotal movement of the second handle portion 234 towards the fixed handle 240 results in movement of the first lever portion 232 which in turn pushes the movable jaw member 220 towards the fixed jaw member 210. A second rear portion of the movable jaw member 220 is connected with a biasing member in the form a biasing spring 264 that is positioned relative to the movable jaw member 220 to resist movement of the movable jaw member 220 towards the fixed jaw member 210. Specifically, a first end of the spring 264 is linked with the second rear portion of the movable jaw 220 and a second end of the spring 264 is linked to the support member 250. The biasing force applied by the spring 264 may be adjusted to suit end use and the strength of the user holding the handle and pulling the lever 230. The positioning of the rear end of the spring 264 within the supporting housing 250 may be used to vary the biasing force. The linking location of the first lever portion 232 may also be used for limiting the extent of permissible arcuate movement for the handle 230 and simultaneous linear movement of the movable jaw 120 towards the fixed jaw. In a neutral position (when no force is applied on the second lever portion), the biasing force of the spring member 164 applies sufficient force on the first lever portion to push the lever 130 back into the open non-firing position. Additionally, a sliding hand engaging portion 242 is also provided on the fixed handle 240. The movement of the sliding hand engaging portion 242 allows users with larger hands to adjust the hand engaging portion 242 to an in-use upper location (proximate to the pivoting location 236) which in turn increases the distance between the hand engaging portion 242 and the second lever portion 234. Users with smaller hands may slide the hand engaging portion 242 downwards (away from the pivoting location 236) which in turn decreases the distance between the hand engaging portion 242 and the second lever portion 234

The above described configuration of the spring member 264 in combination with the first lever portion 232 and the movable jaw member 220 allows the initial spacing (in the open or no-fired position) between the movable jaw 220 and fixed jaw 210 to be varied for accommodating tags of varying thicknesses. By way of example, using a longer spring 264 would result in the overall spacing between the movable jaw 220 and the fixed jaw 210 to be reduced. Similarly, a grub screw 265 may also be used in conjunction with the second end of the spring member 264 to vary the bias applied by the spring and thereby changing the neutral spacing between the movable jaw 220 and the fixed jaw 210.

In another embodiment or modification of the ear tag applicator referred to as 200A and shown in FIGS. 12C and 12D, the biasing spring 264 from the previous embodiment may be replaced with a biasing spring 264A positioned between the second portion 234 of the lever 230 and the handle 240 for applying a bias for resisting the pivotal movement of the second lever portion 234 towards the handle 240. FIG. 12D shows the ear tag applicator 200A in a firing position when a user has applied a force to overcome the bias of the biasing spring 264A to push the movable jaw member 220 towards the fixed jaw member 210. Once the user stops applying any force on the lever 230, the spring member 264A urges the lever 230 to pivot away from the handle 240 thereby resulting in the linked movable jaw member 220 to be moved away from the fixed jaw member 210 through a sliding movement of the movable jaw member 220 (relative to the supporting member 250).

The housing members 250A and 250B are also shaped for limiting the sliding movement of the movable jaw member 220 in a direction towards the fixed jaw member 210 and in a direction away from the fixed jaw member 210. Typically, a first portion of the movable jaw member 220 may abut the housing 250 at a first abutment location adjacent the linking portion of the handle 230. Similarly, a second portion of the moving jaw member 210 may abut the inner wall of the housing (250A and 250B) for the supporting member 250 to limit the sliding movement of the movable jaw 220 in a direction away from the fixed jaw member 210.

The animal tag applicator 200 also includes an actuator 266 (shown in FIG. 15) for actuating for actuating one or more electronic components that may be present in the animal tag being applied. The actuator 266 in some non-limiting embodiments may be an RFID actuator for actuating the electronic components in an animal tag placed in the vicinity of the tag engaging surface 215. An indicator such an indicator light 260 (shown in FIGS. 7, 8 and 11B) may indicate the active state of the electronic tag. In the preferred embodiment, the indicator light is shown on outer surface of the housing for the supporting member 250.

As explained in the earlier sections, the applicator tool 200 according to embodiment of the invention comprises jaws 210 and 220 that can be sufficiently spaced apart to permit ready positioning on an animal's ear in between the jaws. In addition, however, there is provided the added advantage of an applicator tool having a lever ratio which is higher than that obtained with equivalent sized known applicators. For example, most known applicators have a lever ratio of approximately 2:1 and adequate space for the positioning of the animal's ear between the tag parts when installed in the applicator. Usually any increase in the space between the ear tag parts results in a lowering of the lever ratio especially if the applicator tool is to remain of dimensions which can be easily handled by the user. With the applicator 200 of the presently described embodiment, a good distance between the ear tag parts is achieved without any sacrifice of the lever ratio. In fact, the applicator can have a lever ratio at the actual installation of the tag in the order of 3:1. As a result, a high lever ratio is attained at the precise moment it is required which is during installation of the tag.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

What is claimed:

1. An animal tag applicator comprising:
a fixed jaw member and a movable jaw member comprising oppositely arranged tag engaging surfaces for engaging an animal tag therebetween;
a handle extending downwardly from the fixed jaw member;
a supporting portion extending outwardly from the fixed jaw member to support the movable jaw member;
a lever comprising a first lever portion linked to the movable jaw and a second lever portion adapted for movement relative to the handle wherein the lever is movably linked to said handle such that a movement of the second portion of the lever towards the handle results in movement of the first portion of the lever and simultaneously effects a substantially linear movement of the linked moveable jaw towards the fixed jaw; and
a biasing arrangement positioned in between the first portion of the lever and the movable jaw to provide a biasing force to initially resist movement of the first lever portion in a direction towards the movable jaw and whereby once the biasing force of the biasing arrangement has been overcome, further movement of the first lever portion effects movement of the movable jaw towards the fixed jaw.

2. An animal tag applicator in accordance with claim 1 wherein the supporting portion extends in an orthogonal and outwardly direction relative to the fixed jaw and the handle.

3. An animal tag applicator in accordance with claim 1 wherein the handle depends downwardly relative to the supporting portion.

4. An animal tag applicator in accordance with claim 1 wherein the fixed jaw, the supporting portion and the handle are integrally formed.

5. An animal tag applicator in accordance with claim 1 wherein the supporting portion comprises a sliding arrangement to allow the movable jaw to slide along at least a portion of the supporting portion thereby allowing movement of the movable jaw towards the fixed jaw.

6. An animal tag applicator in accordance with claim 5 wherein the sliding arrangement comprises engagement formations provided along a lower portion of the movable jaw for slidably engaging the supporting portion.

7. An animal tag applicator in accordance with claim 5 wherein the sliding arrangement comprises engagement formations provided along lateral walls of a rear portion of the movable jaw member for slidably engaging channels provided within a housing of the supporting portion.

8. An animal tag applicator in accordance with claim 1 wherein lever comprises a linking portion positioned between the first and second lever portions for pivotally linking the lever and allowing pivotal movement of the lever relative to the handle to effect the movement of the movable jaw towards the fixed jaw.

9. An animal tag applicator in accordance with claim 8 wherein the handle further comprises a movable hand engaging portion configured for movement along a body of the handle, the hand engaging portion being operable to be movable towards and away from the linking portion of the lever.

10. (canceled)

11. An animal tag applicator in accordance with claim 1 further comprising an adjustment mechanism for adjusting a bias applied by the biasing arrangement.

12. An animal tag applicator in accordance with claim 1 wherein the first portion of the lever is linked to a first linking portion of the movable jaw and wherein the biasing member is linked to a second linking portion of the movable jaw.

13. An animal tag applicator in accordance with claim 12 wherein the biasing member is elongate and extends between two ends, a first end of the biasing member being linked with the second linking portion of the movable jaw and the second end of the biasing member being linked with the supporting member.

14. An animal tag applicator in accordance with claim 1 wherein the movable jaw is positioned for sliding for within a cavity defined by a housing to surround and enclose the first and second linking portions of the movable jaw and the first lever portion therein.

15. An animal tag applicator in accordance with claim 1 further comprising a guide member extending in a rearwardly direction relative to the engaging surface of the movable jaw, the guiding member being positioned for guiding movement of the first lever portion towards the movable jaw.

16. An animal tag applicator in accordance with claim 15 wherein the first portion of the lever comprises a slot for receiving the guiding member therein, the slot being shaped to limit upward or downward movement of the first lever portion relative to the guide member.

17. An animal tag applicator in accordance with claim 15 wherein the biasing member is positioned relative to the guide member to resist initial guided movement of the first lever along the guiding member towards the movable jaw.

18. An animal tag applicator in accordance with claim 15 wherein a rear portion of the movable jaw comprises two spaced apart rear portions for receiving the first portion of the lever when the second portion of the lever is pivoted towards the handle.

19. An animal tag applicator in accordance with claim 18 wherein a lower part of each of the rear portions comprises engagement formations for slidably engaging the support portion and allowing the movable jaw to slide along the support portion.

20. An animal tag applicator in accordance with claim 1 wherein the tag engaging surface in each of said jaws is recessed inwardly relative to an outer surface of the jaw for receiving a portion of the tag during use.

21. An animal tag applicator in accordance with claim 1 further comprising an actuating arrangement for actuating one or more electronic components of the animal tag positioned between the fixed and movable jaws during use.

22. An animal tag applicator in accordance with claim 21 wherein the actuating arrangement comprises an RFID tag powered by a battery, said arrangement being located at or adjacent the tag engaging surface of the fixed jaw member.

23. An animal tag applicator in accordance with claim 21 further comprising an indicator for indicating a state of operation of the animal tag positioned between the fixed and movable jaws during use.

24. An animal tag applicator comprising:
a fixed jaw member and a movable jaw member comprising oppositely arranged tag engaging surfaces for engaging an animal tag therebetween;
a lever comprising at least a first lever portion linked to the movable jaw by a linking arrangement such that pivotal movement of the lever simultaneously effects a substantially linear movement of the linked moveable jaw towards the fixed jaw; and
a biasing arrangement positioned in between the first portion of the lever and the movable jaw to provide a biasing force to initially resist movement of the first lever portion in a direction towards the movable jaw and whereby once the biasing force of the biasing arrangement has been overcome, further movement of the first lever portion effects movement of the movable jaw towards the fixed jaw.
